(19) United States
(12) Patent Application Publication
(10) Pub. No.: US 2011/0178812 A1
(43) Pub. Date: Jul. 21, 2011

(54) Device for Automatically Issuing a Prescription for a Prescription Product

(76) Inventor: Noel P. Lindsay, Ross, CA (US)

(21) Appl. No.: 12/688,714

(22) Filed: Jan. 15, 2010

(51) Int. Cl. G06Q 50/00

(52) U.S. Cl. 705/2

(57) ABSTRACT

A device for automatically generating a prescription for a prescription product is disclosed. The device comprises a user interface, a questionnaire engine, a processing engine, and a prescription generation engine. The questionnaire engine is configured to provide a questionnaire to a user and receive user response data through the user interface. The processing engine is configured to automatically determine whether the user response data satisfies prescription requirements. The prescription generation engine is configured to be executed by a processor to issue the prescription for a prescription product for a satisfied standing order.

### BACKGROUND

Prescriptions are created (or “issued”) by authorized healthcare professionals for patients who require a product only available via prescription. Traditionally, a prescription is issued by the healthcare professional and then presented to a pharmacy or other service that can “fill” the prescription by providing the prescribed product to the patient. Typically, the pharmacy has a staff of trained professionals that can receive the prescription order and fill the order for the patient when the patient travels to the pharmacy.

In addition to the typical pharmacy, some issued prescriptions can be filled without the patient having to interact with trained professionals that provide the prescribed product. For example, a prescription service may fill a prescription for a patient and place the prescribed product in a secure location for the patient, such as a locker. These lockers can be placed in a convenient location for the patient, such as the patient's workplace.

Though prescription products can be picked up from convenient locations by a patient, the prescription itself still requires the patient to visit a healthcare professional to have the prescription issued.

### BRIEF SUMMARY OF THE INVENTION

Embodiments of the present invention provide systems, methods, and media for automatically generating a prescription by a healthcare professional for a prescription product. A prescription can be a set of instructions that govern a plan of care for a patient, and can be associated with a prescription product. Prescription products can be, for instance, a drug, a device, or any combination thereof. A prescription can be issued by a healthcare professional, for instance a physician, nurse practitioner, or dentist, any of whom can be a prescriber. The present systems, methods, and media provide for automatically generating a prescription from a response to a questionnaire and may not involve physical inspection of the patient. The prescription can be automatically issued when a questionnaire response that fulfills a set of criteria provided by the prescribing healthcare professional is received. These criteria can be specified in or otherwise associated with a standing order to dispense a prescription product, for instance, a prescription anti-snoring device, when it has been determined that a threshold determination, such as for example all of the criteria, have been met.

In a first aspect, a device for automatically generating a prescription for a prescription product is disclosed. The device comprises a user interface, a questionnaire engine, a processing engine, and a prescription generation engine. The questionnaire engine is configured to provide a questionnaire to a user and receive user response data through the user interface. The processing engine is configured to automatically determine whether the user response data satisfies prescription requirements. The prescription generation engine is configured to be executed by a processor to issue the prescription for a prescription product for a satisfied standing order.

In a second aspect, a method for automatically generating a prescription for a prescription product is disclosed. A standing order for the prescription product is received via a network. A user response to a questionnaire is received. Instructions that are stored in memory are executed to automatically determine, by a prescription processing engine, whether the user response satisfies the standing order. Instructions that are stored in memory are executed to issue the prescription, by a prescription processing engine, for the prescription product for a satisfied standing order.

In a third aspect, a computer readable storage medium is disclosed. The computer readable storage medium includes a program being executable by a computer to perform a method for generating a prescription for a prescription product. The method comprises receiving a standing order for the prescription product via a network, receiving a user response to a questionnaire over the network, automatically determining whether the user response satisfies the standing order and generating the prescription for the prescription product for a satisfied standing order.

### BRIEF DESCRIPTION OF THE DRAWINGS

FIG. 1 is a block diagram of an exemplary networking environment in accordance with embodiments of the present invention.

FIG. 2 is a block diagram of an exemplary computing environment in accordance with embodiments of the present invention.

FIG. 3 is a block diagram of an exemplary prescription processing engine in accordance with embodiments of the present invention.

FIG. 4 is a flow chart of an exemplary computer-implemented method for automatically generating a prescription for a prescription product.

FIG. 5 is a flow chart of an exemplary computer-implemented method for automatically determining whether a user response satisfies a standing order in accordance with the methods discussed in the context of FIG. 4.

### DETAILED DESCRIPTION

Embodiments of the present invention provide systems, methods, and media for automatically generating a prescription for a prescription product. A prescription can be a set of instructions that govern a plan of care for a patient, and can be associated with a prescription product. Prescription products can be, for instance, a drug, a device, or any combination thereof. A prescription can be administered by a healthcare professional, for instance a physician, nurse practitioner, optician, or dentist. The present systems, methods, and media provide for automatically generating a prescription from a response to a questionnaire and may not involve physical inspection of the patient. In addition, the prescription can be automatically issued when user data is received that fulfills all or a certain portion of a set of criteria provided by the healthcare professional. This user data may be, for example, in the form of user responses to a questionnaire. These criteria can be associated with a standing order of a prescription product, which may be written by a healthcare professional. The prescription may therefore be issued in view of criteria set forth by the healthcare professional in the standing order. Although the present disclosure focuses on prescribing anti-snoring devices, it is contemplated that this disclosure applies to automatically generating prescriptions for any prescription product, based on standing orders written by healthcare professionals.

The systems, methods, and media described herein may make use of computerized questionnaires or other user data received in response to an inquiry to a patient in order to determine whether a patient fulfills criteria for a standing order and/or a prescription. The questionnaires can be made available to patients via the Internet or other network to a client device associated with a patient, such as a desktop computer or a mobile device. The questionnaires may also be administered to a patient at a kiosk used to dispense the prescription product. The questionnaire may include a plurality of questions drawn to, for instance, health conditions, symptoms, and demographic information. A patient can be a user of the systems, methods, and media described who provides a questionnaire response. A questionnaire response may include a questionnaire received by the systems as disclosed herein with no questions answered, a portion of the questions answered, and all questions answered. In some embodiments, the questionnaire response may include comments provided by the patient. The patient may provide the questionnaire response via the Internet or another online network.

A healthcare professional may also be a user of the system as an authorized prescriber of a prescription product. The authorized prescriber can be associated with a standing order of a prescription product. The standing order can be satisfied upon receiving a questionnaire response in accordance with prescription requirements, as is described more fully herein, and the prescription product can be dispensed pursuant to a prescription issued through a standing order. In some embodiments, the authorized prescriber may manage one or more standing orders associated with one or more prescription products. A prescription product may likewise, have several authorized prescribers.

Though the following discussion exemplifies the use of questionnaires in automatically generating prescriptions for prescription products, further applications and variations will become apparent to one skilled in the art upon review of this disclosure.

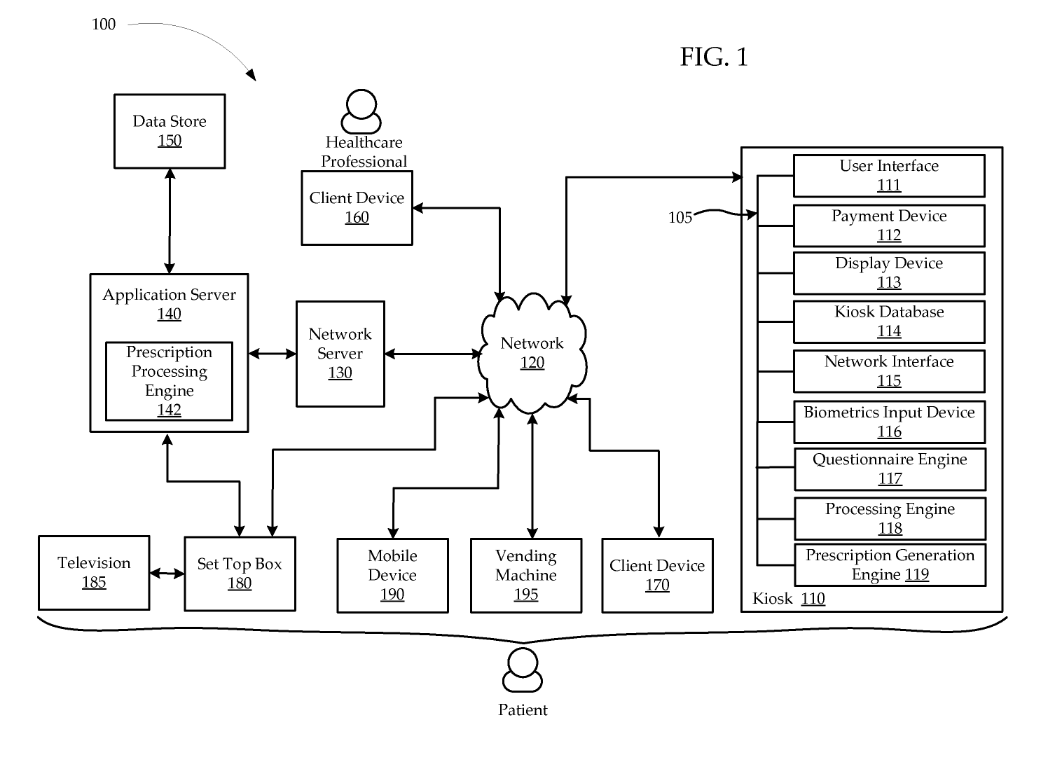

FIG. 1 is a block diagram of an exemplary Networking Environment 100 in accordance with embodiments of the present invention. The networking environment includes Kiosk 110, Network 120, Network Server 130, Application Server 140 with Prescription Processing Engine 142, Data Store 150, Client Devices 160 and 170, Set Top Box 180, Television 185, Mobile Device 190 and Vending Machine 195. In some embodiments, Client Devices 160 and 170 may be implemented as computers having a processor that runs software stored in memory, wherein the software may include network browser applications (not shown) configured to render content pages, such as web pages, from network server 130.

Kiosk 110 includes User Interface 111, Payment Device 112, Display Device 113, Kiosk Database 114, Network Interface 115, Biometrics Input Device 116, Questionnaire Engine 117, Processing Engine 118, and Prescription Generation Engine 119, which can be in communication with each other and with Network 120 via Bus 105. Kiosk 110 may also include one or more processors configured to execute software, such as prescription generation engine 119, stored in memory within kiosk 110.

User interface 111 can include a display device, keyboard, microphone, speakers, and other input and output devices for communicating with a patient at Kiosk 110. Payment device 112 can include a credit/debit card processing and authorization device and currency payment device for accepting and authenticating currency. Display device 113 can include a digital display device for displaying a graphical user interface or other information. In some embodiments, the display device may be a touch screen display for receiving input in addition to providing an output display. Kiosk database 114 can include memory for storing, deleting, modifying and creating data in the course of kiosk operation. Network interface 115 can include an interface for external communication over network 120 or some other network. Biometrics input device 116 can include a retinal scanner, fingerprint scanner, or other device for inputting biological data from a patient.

Each of questionnaire engine 117, processing engine 118 and prescription generating engine 119 can be stored in memory and executed by a processor to perform operations in the course of automatically providing a prescription to a patient. Each of engines 117, 118 and 119 are described in more detail below.

One skilled in the art will recognize that any number of elements 110-195 can be present in Networking Environment 100 and that the exemplary methods described more fully herein can be executed by one or more of elements 110-160. For all figures mentioned herein, like numbered elements refer to like elements throughout.

Network 120 can be any type of network, including but not limited to the Internet, LAN, WAN, a telephone network, and any other communication network that allows access to data, as well as any combination of these. In some embodiments, Network 120 is coupled to Kiosk 110, Client Devices 160 and 170, Network Server 130, Mobile Device 190, Vending Machine 195 and Set Top Box 180 as shown in FIG. 1. Additionally, Network 120 can be coupled to Application Server 140 (not shown in FIG. 1). Networking Environment 100 is exemplary and not limited to what is shown in FIG. 1.

Client devices 160 and 170 can be any computing device, including, but not limited to desktop computers, laptop computers, mobile devices, and portable digital assistants (PDAs). Each of the client devices 160 and 170 can communicate with a web service provided by network server 130 and application server 140 as well as with kiosk 110 over network 120.

Set top box 180 may communicate with the Application Server 140 and/or Network Server 130 via the Network 120 and provide interface information through a television 185. In some embodiments, television 185 may include components, circuitry, hardware or software for communicating with application server 140 directly rather than through set-top box 180. The set-top box may be configured to provide interactive commercials for display, such as interactive commercials for the prescription product. Patient input may be received by set-top box 180 and communicated to application server 140. For instance, the application server 140 may provide a questionnaire for display on the television in response to a set top box request initiated by a patient. The patient may provide input to the set-top box to provide answers to the questionnaire, and set top box 180 may transmit the user input (e.g., questionnaire responses) to application server 140. Additionally, the application server 140 may provide further information for display upon a patient request. This information may include, for instance, medical information which is not provided in the interactive commercial, patient location information, preferred location to pick-up a prescribed product, and other information.

Mobile Device 190 communicates with the Application Server 140 via the Network 120. Mobile Device 190 may include a memory, processor, and display, and store an executable application. The executable application may be executed by the processor to implement questionnaires, place a patient in communication with a healthcare professional (e.g., via chat, telephone, or email), receive input and provide output through the mobile device, and perform other functionality, such as the communication functionality described with respect to a kiosk. Mobile Device 190 may be implemented as a mobile phone, PDA or other mobile device.

Vending Machine 195 may be receive input from a patient and communicate with the Application Server 140 via the Network 120. The Vending Machine 195 may include a memory, processor, and display, in addition to a dispensing device. Vending Machine 195 may additionally store an executable application, which may be executed by the processor to place a patient in contact with a healthcare professional, display an advertisement for a prescription product, dispense a prescription product and/or perform other functionality such as those discussed in the context of the Kiosk 110. In some embodiments, a vending machine may communicate with Application Server 140 to confirm patient identification information received from a user at Vending Machine 195. Vending Machine 195 may also dispense a prescription product based on information received from a patient and/or data received from application server 140, such as for example identification of a prescription product to dispense to the patient.

Application Server 140 can communicate with Network Server 130 and Data Store 150. It will be apparent to one skilled in the art that the embodiments of this invention are not limited to any particular type of server and/or database. In some embodiments, the servers mentioned herein are configured to control and route information via the Network 120 or any other networks (not shown in FIG. 1). The servers herein may access, retrieve, store and otherwise process data stored on any of the databases mentioned herein.

Data Store 150 and kiosk database 114 can store patient information such as government identification numbers, credit card numbers, biometric data and account information. Data Store 150 as well as kiosk database 114 can store data, which includes, but is not limited to, questionnaires, questionnaire responses, standing orders, issued prescriptions, contact information for patients and healthcare professionals, and electronic communication between healthcare professionals and patients. Data Store 150 and kiosk database 114 can also store historical action logs associated with server activity, e.g. date and time information associated with when questionnaires responses are received from a Client Device 170, when prescriptions were issued, and when prescription products were dispensed to the patient.

Any number of any of elements 110-195 can be present in Networking Environment 100, and Networking Environment 100 is configured to serve these elements. For example, Network Server 130 may provide a questionnaire via Network 120 to a plurality of Client Devices 160 and 170 despite only two clients shown in FIG. 1. Network Server 130 may also provide a questionnaire via Network 120 to a plurality of Kiosks 110, Set Top Boxes 180, Televisions 185, Mobile Devices 190, and Vending Machines 195 despite only one client shown in FIG. 1.

In some embodiments, Application Server 140 may provide a questionnaire to Client Devices 160 and 170, Kiosk 110, and any combination thereof. A user of Kiosk 110, e.g., a patient, may communicate a user response, e.g., a questionnaire response to Kiosk 110 via User Interface 111. For instance, the questionnaire may include a question asking for the patient's height and/or weight, and the patient may provide a questionnaire response indicating the same. The questionnaire can be provided for display on, for instance, Display Device 113 of the Kiosk 110, and the patient may use User Interface 111 to communicate questionnaire responses to Kiosk 110. The questionnaire response can be communicated via Network 120 and Network Server 130 to Prescription Processing Engine 142 of Application Server 140.

The questionnaire response can be evaluated by Prescription Processing Engine 142. As part of this evaluation, Prescription Processing Engine 142 can be executed to access Data Store 150 for prescription requirements and evaluate the questionnaire response based on the prescription requirements. Prescription requirements may include, for example, criteria that patients may, should, and/or must fulfill in order to qualify for a prescription. For instance, a prescription product such as a prescription anti-snoring device may require that a patient be older than eighteen years of age, not have full dentures, not have loose teeth, etc. The prescription requirements can be specified by and/or associated with a standing order for the prescription product. Standing orders can be further associated with one or more authorized prescribers of the prescription product, such as a healthcare professional, as is described more fully herein. In some embodiments, each prescriber may generate his or her own standing order for each prescription product.

In evaluating the questionnaire response, Prescription Processing Engine 142 at Application Server 140 can be executed to automatically determine whether the questionnaire response satisfies prescription requirements associated with a standing order. A standing order may include some or all prescription requirements. In some embodiments, a questionnaire response can be compared with one or more standing orders and determined to satisfy a standing order if the questionnaire response answers provided by a questionnaire subject match a standing order retrieved from Data Store 150. Alternatively, if a questionnaire response meets, for instance, one or more prescription requirements, the standing order can be satisfied. For example, for a prescription pain medication, a question may ask a patient to rate, on a scale of one to ten, their level of pain. The patient may provide a pain level of 8 when the threshold level of pain for the question set by the standing order is 4 or greater, thereby satisfying the standing order.

If Prescription Processing Engine 142 determines that the questionnaire response satisfies the standing order, then a prescription for the prescription product can be dispensed to the patient. In some embodiments, Prescription Processing Engine 142 may provide computerized instructions to Kiosk 110 or Client Device 170 to issue and provide a prescription to the patient and/or dispense the prescription product from Kiosk 110 via a kiosk dispensing mechanism (not shown in FIG. 1). Alternatively, Prescription Processing Engine 142 may issue the prescription and transmit and/or otherwise communicate the prescription to the patient at Kiosk 110 or Client Device 170 via Network 120. The prescription can be printed at Kiosk 110 in hardcopy and/or softcopy for the patient's records. The prescription may additionally be transmitted and/or otherwise communicated to the authorized prescriber associated with the satisfied standing order.

Upon generating the prescription, an inventory of the prescription product associated with standing order can be updated. For instance, if a standing order associated with an authorized prescriber indicates ten units of a prescription product in inventory, the standing order can be updated to nine units of prescription product upon issue of the prescription. Alternatively, the standing order can be updated when the prescription product is dispensed to the patient for whom the prescription is issued. In some embodiments, the issued prescription can be stored in association with the standing order and inventory information in Data Store 150.

If the questionnaire response satisfies the standing order, the Prescription Processing Engine 142 may generate a user account for the patient. Patient information can be stored in association with the user account in Data Store 150. Patient information may include, but is not limited to patient contact information such as an e-mail address, telephone numbers, government identification numbers, and/or mailing address, authorized prescriber information, a softcopy of the prescription, billing information such as credit card information, and an indication as to whether the prescription product has been dispensed to the patient. The patient may access the user account from Kiosk 110 or Client Device 170 at a future time, and may protect the user account via, for instance, a username and password.

The Networking Environment 100 may allow healthcare professionals to provide prescriptions on their behalf via Prescription Processing Engine 142. As shown in FIG. 1, a healthcare professional may, via Client Device 160 or Kiosk 110, communicate with Application Server 140 via Network 120. A healthcare professional may provide prescriptions by writing a standing order for a prescription product. In some embodiments, a healthcare professional may identify himself or herself to Prescription Processing Engine 142 via, for instance, a professional license code, biometric identifier, or any combinations thereof. Prescription Processing Engine 142, after identifying the healthcare professional, may provide options for which prescription products (e.g. prescription drugs, prescription devices, and any combinations thereof) for which the healthcare professional may generate a standing order. These options can be displayed, for instance on Display Device 113 or a display device associated with Client Device 160 (display device not shown). The healthcare professional may select one or more prescription products for which to generate a standing order.

Upon selection of a prescription product, Prescription Processing Engine 142 can be executed to generate a questionnaire based on prescription requirements. Prescription requirements can be defined by the healthcare professional based on the questions selected by the healthcare professional. In addition, Prescription Processing Engine 142 can be executed to provide a mandatory question to be asked in the questionnaire. Mandatory questions may reflect prescription requirements of a manufacturer of the prescription product. For instance, in the case of a standing order for a prescription anti-snoring device, a question that differentiates central sleep apnea patients from ordinary snorers can be a mandatory question, in order to determine whether the patient qualifies for the prescription anti-snoring device. Prescription Processing Engine 142 can be executed to provide assistance in generating the questionnaire, for instance, providing statistics related to frequency of selection of particular questions for the questionnaire and/or providing an analysis of the potential questionnaire responses that can be received in response to the question. Thus, a questionnaire generated by a healthcare professional may reflect that individuals' evaluation of the importance of various factors in determining whether to dispense the prescription product to the patient.

The healthcare professional, upon selecting the questionnaire, may provide questionnaire responses that, if received from a patient associated with Client Device 170, would satisfy the standing order. For instance, in the case of a prescription anti-snoring device, a dentist may establish that a patient who provides a questionnaire response indicating herself as a “frequent” snorer satisfies that dentist's standing order. Prescription Processing Engine 142 may also provide assistance to the healthcare professional for in determining which questionnaire responses satisfy the standing order. The healthcare professional may provide questionnaire responses for some or all of the questions in the questionnaire.

Upon selection the questions and optionally, providing questionnaire responses, the standing order can be generated. In some embodiments, Prescription Processing Engine 142 may process a payment associated with the standing order. The standing order can be stored in Data Store 150 and/or Kiosk Database 114 for future retrieval as discussed above. The healthcare professional may thus be recognized by the Prescription Processing Engine 142 as an authorized prescriber of the prescription product.

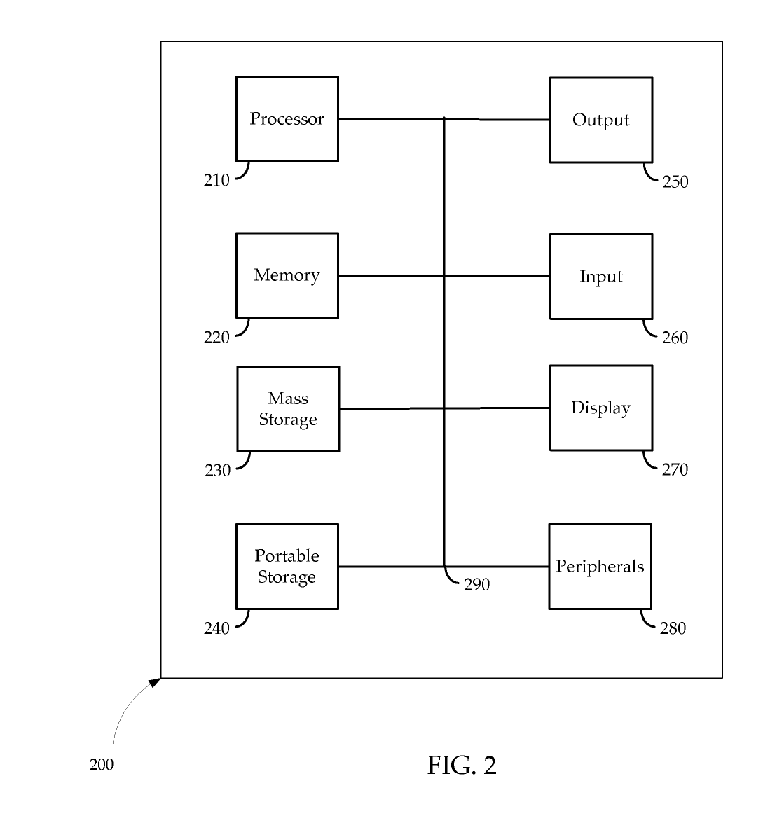

FIG. 2 is a block diagram of an exemplary computing device for automatically generating a prescription for a prescription product in accordance with embodiments of the present invention. In some embodiments, the exemplary computing device of FIG. 2 can be used to implement portions of Client Devices 160 and 170, Network Server 130, Application Server 140, Data Store 150, Kiosk 110, Set Top Box 180, Mobile Device 190, and Vending Machine 195.

The computing system 200 of FIG. 2 includes one or more processors 210 and memory 220. Main memory 220 stores, in part, instructions and data for execution by processor 210. Main memory 220 can store the executable code when in operation. The system 200 of FIG. 2 further includes a mass storage device 230, portable storage medium drive(s) 240, output devices 250, user input devices 260, a graphics display 270, and peripheral devices 280.

The components shown in FIG. 2 are depicted as being connected via a single bus 290. However, the components can be connected through one or more data transport means. For example, processor unit 210 and main memory 220 can be connected via a local microprocessor bus, and the mass storage device 230, peripheral device(s) 280, portable storage device 240, and display system 270 can be connected via one or more input/output (I/O) buses.

Mass storage device 230, which can be implemented with a magnetic disk drive or an optical disk drive, is a non-volatile storage device for storing data and instructions for use by processor unit 210. Mass storage device 230 can store the system software for implementing embodiments of the present invention for purposes of loading that software into main memory 220.

Portable storage device 240 operates in conjunction with a portable non-volatile storage medium, such as a floppy disk, compact disk or Digital video disc, to input and output data and code to and from the computer system 200 of FIG. 2. The system software for implementing embodiments of the present invention can be stored on such a portable medium and input to the computer system 200 via the portable storage device 240.

Input devices 260 provide a portion of a user interface. Input devices 260 may include an alpha-numeric keypad, such as a keyboard, for inputting alpha-numeric and other information, or a pointing device, such as a mouse, a trackball, stylus, or cursor direction keys. Additionally, the system 200 as shown in FIG. 2 includes output devices 250. Examples of suitable output devices include speakers, printers, network interfaces, and monitors.

Display system 270 may include a CRT, a liquid crystal display (LCD) or other suitable display device. Display system 270 receives textual and graphical information, and processes the information for output to the display device.

Peripherals 280 may include any type of computer support device to add additional functionality to the computer system. For example, peripheral device(s) 280 may include a modem or a router.

The components contained in the computer system 200 of FIG. 2 are those typically found in computer systems that can be suitable for use with embodiments of the present invention and are intended to represent a broad category of such computer components that are well known in the art. Thus, the computer system 200 of FIG. 2 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

As discussed above, Kiosk 110 (as discussed in the context of FIG. 1) may conform to the exemplary computing device discussed in the context of FIG. 2. Kiosk 110 includes User Interface 111, Payment Device 112, Display Device 113, Kiosk Database 114, Network Interface 115, Biometrics Input Device 116, Questionnaire Engine 117, Processing Engine 118, and Prescription Generation Engine 119, as shown in FIG. 1. Elements of Kiosk 110 may conform to elements shown in the context of FIG. 2. For instance, User Interface 111 and/or Biometrics Input Device 116, Display Device 113, Kiosk Database 114, may correspond to Peripherals 280, Display 270, Mass Storage 230 and/or Portable Storage 240, respectively.

In some embodiments, Kiosk 110 may issue a prescription for a prescription product without requiring the presence of a healthcare professional (or other human operator) or performing any sort of physical evaluation or physical examination of a patient. Kiosk 110 may generate, via Questionnaire Engine 117, a questionnaire associated with a prescription product. In some embodiments, the questionnaire may be associated with a healthcare professional. Kiosk 110 may provide for display the questionnaire via Display Device 113 and receive questionnaire responses from a patient via User Interface 111 via Questionnaire Engine 117. Display Device 113 and User Interface 111 can be integrated, for instance, in a touchscreen. In some embodiments, Kiosk 110 may receive biometric data, for instance a fingerprint, and/or the like to identify the patient. Further, Questionnaire Engine 117, Processing Engine 118, and Prescription Generation Engine 119 can be executable by Processor 210.

Upon receiving a questionnaire response from a patient, Kiosk 110 may transmit the questionnaire response to Prescription Processing Engine 142 via Network Interface 115, which is configured to establish a connection to Network 120. Prescription Processing Engine 142 may evaluate the questionnaire response as discussed above in the context of FIG. 1. Alternatively, Kiosk 110 may evaluate the questionnaire response locally at Kiosk 110. The questionnaire response can be evaluated by Processing Engine 118, which may retrieve standing orders from Kiosk Database 114, and Processing Engine 118 may automatically determine whether the questionnaire response satisfies a standing order.

Alternatively, the questionnaire response may not satisfy a standing order stored in Kiosk Database 114. Processing Engine 118 can be executed to communicate, for instance, the questionnaire response to Prescription Processing Engine 142 for a standing order from Data Store 150. Alternatively, Processing Engine 118 may partially process the questionnaire response. For instance, Processing Engine 118 may determine a set of prescription requirements that are satisfied by the questionnaire response, and transmit computerized instructions and/or a query to Prescription Processing Engine 142 for a standing order stored in Data Store 150 that the questionnaire response may satisfy. If the questionnaire response satisfies a standing order stored locally at Kiosk Database 114, then a prescription can be issued via Prescription Generation Engine 119 at Kiosk 110.

In some embodiments, the patient may specify, in the questionnaire response, an authorized prescriber of the prescription product. For instance, in the example of a prescription anti-snoring device, the patient may specify her dentist. Questionnaire Engine 117 may determine the specified prescriber of the prescription product, and retrieve a standing order associated with the specified prescriber from either of Kiosk Database 114 and/or Data Store 150. The questionnaire response can be evaluated against the prescription requirements selected by the specified prescriber (authorized by Prescription Processing Engine 142) in the standing order. If for instance, the questionnaire response does not satisfy the standing order, the patient can be prompted by Kiosk 110 to specify another prescriber of the prescription product.

Upon generating the prescription, Kiosk 110 may, via Payment Device 112, accept payment for the prescription product. Payment can be in the form of coins/bills, credit card, debit card, and other forms of payment. Kiosk 110 may validate the payment and transmit payment information to Prescription Processing Engine 142. Kiosk 110 may then dispense the prescription product according to the issued prescription.

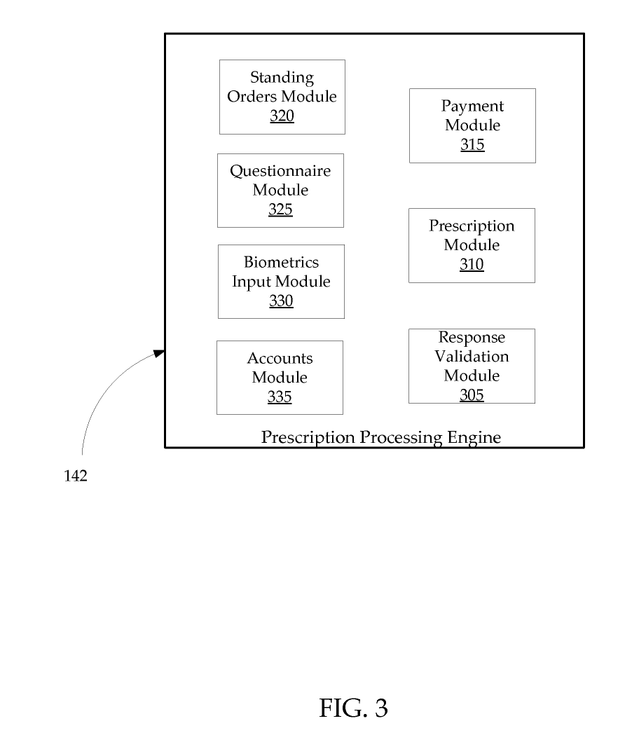

FIG. 3 is a block diagram of an exemplary prescription processing engine in accordance with embodiments of the present invention, such as Prescription Processing Engine 142 discussed in the context of FIGS. 1 and 2. Prescription Processing Engine 142 may include a Response Validation Module 305, a Prescription Module 310, a Payment Module 315, a Standing Orders Module 320, a Questionnaire Module 325, a Biometrics Input Module 330, and an Accounts Module 335. Each module of Prescription Processing Engine 142 can be implemented by software which can be stored in memory and executed by a processor. Patients, healthcare professionals, and prescribers may communicate with Prescription Processing Engine 142 via Client Devices 160 and 170 or Kiosks 110, via Network 120, as is described more fully herein.

A patient, via Client Device 170, may interface with Prescription Processing Engine 142 when obtaining a prescription for a prescription product. Questionnaire Module 325 can be executed to select a questionnaire to provide to a patient in several ways. For instance, Questionnaire Module 325 may randomly select a questionnaire from Data Store 150 or Kiosk Database 114 to provide for display. By randomly selecting a questionnaire, Questionnaire Module 325 also selects the associated standing order and associated authorized prescriber. Alternatively, as discussed above, a patient may communicate a request for a particular healthcare professional who is an authorized prescriber. Thus, the patient, via selection of an authorized prescriber, selects the questionnaire associated with that authorized prescriber.

Questionnaire Module 325 can be executed to also select a questionnaire based on aspects of the standing orders stored in either of Data Store 150 and/or Kiosk Database 115. For instance, two dentists and authorized prescribers, A and B, may each have a standing order for a prescription anti-snoring device stored in Data Store 150. A may have a standing order of ten units of the prescription anti-snoring device whereas B may have a standing order of twenty units. Questionnaire Module 325, based on the higher number of units in B's standing order, may provide B's questionnaire for display in lieu of A's. Alternatively, a patient may enter a location identifier, for instance, a zip code, which indicates a proximate location to A. Questionnaire Module 325 may, based on A's proximate location, provide A′s questionnaire to the patient, in lieu of B's. Instructions that govern the selection of questionnaires to be provided for display, such as those discussed in the examples above, may therefore be embodied in an algorithm executable by Questionnaire Module 325.

A patient may provide questionnaire responses to the questionnaire via Network 120. In some embodiments, questionnaire responses may include receiving biometric information from the patient, for instance, a fingerprint scan. Such responses can be received and/or analyzed by Biometrics Input Module 330. Questionnaire responses can be received and processed by Questionnaire Module 325, upon which the questionnaire responses and/or biometric information can be passed to Response Validation Module 305. Response Validation Module 305 may access the questionnaire responses provided by the authorized prescriber associated with the questionnaire. Response Validation Module 305 may, by determining whether the questionnaire response meets the prescription requirements, determine whether the questionnaire responses satisfy the standing order of the authorized prescriber.

If Response Validation Module 305 determines that the questionnaire response satisfies the standing order, then the Response Validation Module may transmit instructions to Prescription Module 310 to issue a prescription. Prescription Module 310 may access a generic prescription template stored in Data Store 150 and/or Kiosk Database 114. Using patient information and information obtained through questionnaire responses, Prescription Module 310 may issue a prescription and provide the prescription to the patient via Network 110. Alternatively, if the authorized prescriber of the satisfied standing order has provided a prescription template, Prescription Module 310 may access the template and issue a prescription using the same. Additionally, Prescription Module 310 may access Data Store 150 and/or Kiosk Database 114 to locate contact information of the authorized prescriber associated with the satisfied standing order and may transmit an electronic message including the prescription to the authorized prescriber.

If Response Validation Module 305 determines that the questionnaire response satisfies the standing order, then the Response Validation Module may transmit instructions to Payment Module 315 to receive payment from the patient. For instance, the prescription can be issued upon receiving payment from the patient. Alternatively, payment can be received, for instance, by Kiosk 110 to issue a prescription and/or prior to dispensing the prescription product. Payment can be received in the form of currency, such as coins and bills, credit card, debit card, and other forms of payment.

If Response Validation Module 305 determines that the questionnaire response satisfies the standing order, Response Validation Module 305 may transmit instructions to Accounts Module 335 to generate a user account for the patient. Patient information can be stored in association with the user account in Data Store 150. Patient information may include, but is not limited to patient contact information such as an e-mail address, telephone numbers, government identification numbers, and/or mailing address, authorized prescriber information, a softcopy of the prescription, billing information such as credit card information, and an indication as to whether the prescription product has been dispensed to the patient. The patient may access the user account from a Kiosk 110 or Client Device 170 at a future time, and may protect the user account via, for instance, a username and password.

A healthcare professional may communicate with Prescription Processing Engine 142 when generating and/or maintaining a standing order. As mentioned above, a healthcare professional may generate, or author, a standing order for a prescription product based on a set of prescription requirements. A healthcare professional can become an authorized prescriber of a prescription product when generating a standing order, as described in the context of FIG. 1. The authorized prescriber may also generate a user account via Accounts Module 335. Prescriber information can be stored in association with the user account in Data Store 150. Prescriber information may include, but is not limited to prescriber contact information, such as an e-mail address, telephone numbers, identification numbers, and/or mailing address, authorized prescriber information, softcopies of patient prescriptions associated with the authorized prescriber's standing order, billing information such as credit card information, and questionnaires and/or questionnaire responses associated with the authorized prescriber.

An authorized prescriber may access Prescription Processing Engine 142 via Standing Orders Module 320 and/or Accounts Module 335. The authorized prescriber may access Prescription Processing Engine 142 via Client Device 160 and/or Kiosk 110 via Network 120.

Standing Orders Module 320 may allow the authorized prescriber to manage any number of standing orders and payments associated with those standing orders. For instance, an authorized prescriber may add additional units of a prescription product to a standing order via Standing Orders Module 320. Standing Orders Module 320 may then update the standing order, and transmit instructions to Payment Module 315 to receive payment for the added units. Further, Standing Orders Module may make payments to an authorized prescriber upon generating prescriptions that satisfy the authorized prescriber's standing order. These payments can be managed and/or viewed by an authorized prescriber via Standing Orders Module 320.

An authorized prescriber may request to review prescriptions issued to patients from her standing order. Standing Orders Module 320 may transmit instructions to Prescription Module 310, which may access issued prescriptions from Data Store 150 and/or Kiosk Database 114 and provide the requested prescriptions for display. The authorized prescriber may also wish to generate a personalized prescription template for use by Prescription Generation Engine 119 and/or Prescription Module 310. The prescription template can be stored in Data Store 150 and/or Kiosk Database 114.

An authorized prescriber may review the questionnaire and questionnaire responses associated with her standing order, and edit her questionnaire and prescription requirements. Standing Orders Module may communicate such edits to Questionnaire Module 325, which may store a new questionnaire in association with the authorized prescriber in Data Store 150.

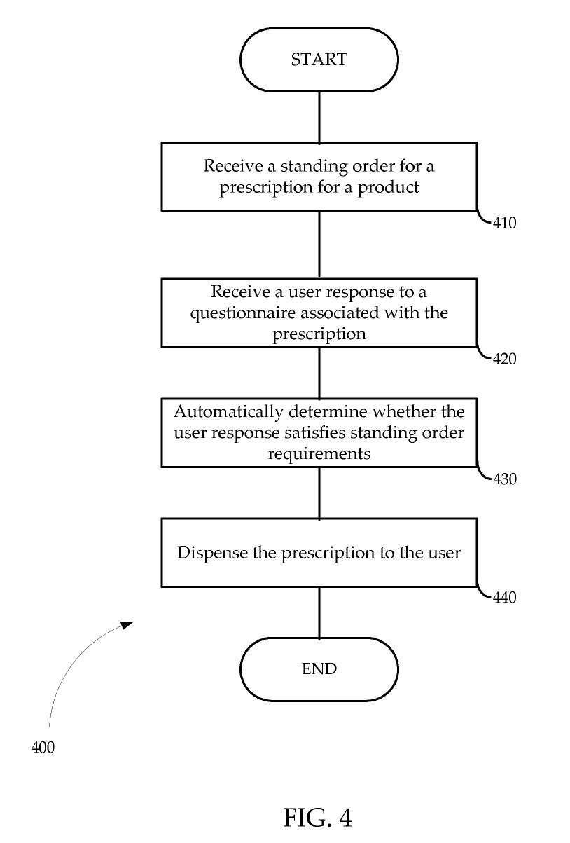

FIG. 4 is a flow chart of an exemplary computer-implemented method for automatically generating a prescription for a prescription product. The method 400 disclosed in FIG. 4 can be practiced in Networking Environment 100 via elements discussed in the context of FIGS. 1, 2, and 3 above.

In step 410, a standing order for a prescription for a product is received. The standing order can be generated by a healthcare professional as discussed above. This can be conducted via, for instance, input ultimately received by Prescription Processing Engine 142 if the healthcare professional is at Client Device 160. Alternatively, if the healthcare professional is at Kiosk 110, the standing order can be generated via input to User Interface 111. The standing order can be generated locally at Kiosk 110 and the generated standing order can be communicated via Network 120. Alternatively, Kiosk 110 may communicate the input to Prescription Processing Engine 142 via Network 120, and the standing order can be generated by Standing Orders Module 320. Upon generating a standing order, a healthcare professional can become an authorized prescriber of a prescription product, and the standing order can be stored in either of Data Store 150 and/or Kiosk Database 114. In some embodiments, a user account can be generated at Accounts Module 335 upon generation of a standing order, and the user account can be stored in Data Store 150.

In step 420, a user response to a questionnaire associated with the prescription is received. The patient may initiate the generation of a prescription by providing a questionnaire response. The questionnaire response can be provided in response to a questionnaire displayed on, for instance, Display Device 113 of Kiosk 110, or on a display device associated with Client Device 170 (client display device not shown in FIG. 1). The questionnaire response can be transmitted to Questionnaire Engine 117 of Kiosk 110. Alternatively, the questionnaire response can be communicated to Questionnaire Module 325 of Prescription Processing Engine 142 via Network 120.

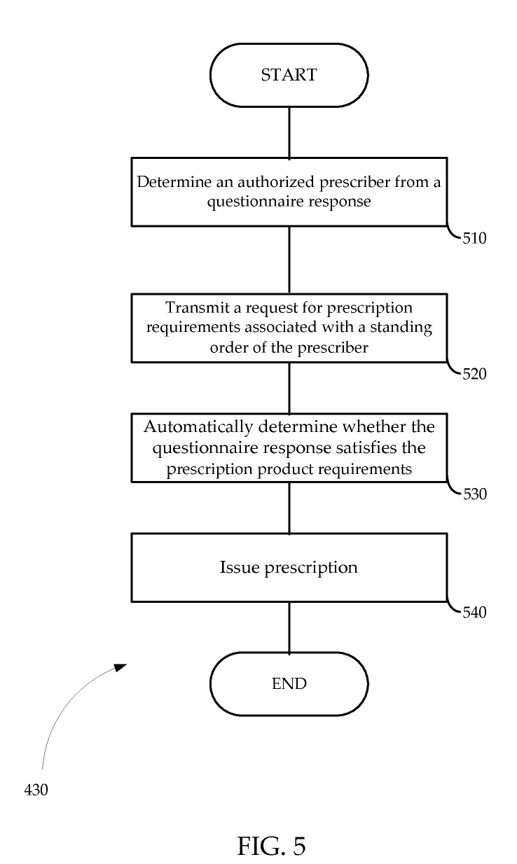

In step 430, a determination is automatically made as to whether the user response satisfies standing order requirements. To make the determination, the questionnaire response can be evaluated by Response Validation Module 305 of Prescription Processing Engine 142. Alternatively, the questionnaire response can be evaluated by Processing Engine 118 of Kiosk 110. Step 430 is further discussed in the context of FIG. 5.

In step 440, a prescription is provided to the patient if a determination has been made in step 430 that the user response satisfies standing order requirements. The prescription can be provided to a user, e.g., a patient and/or an authorized prescriber of the prescription product. The prescription can be issued by Prescription Module 310 of Prescription Processing Engine 142 and communicated to Client Devices 160 and 170 and/or Kiosk 110. Alternatively, the prescription can be issued by Prescription Generation Engine 119 of Kiosk 110. The prescription can be issued based on a personalized template as defined by an authorized prescriber, which can be accessed from Data Store 150 and/or Kiosk Database 114 as discussed above.

FIG. 5 is a flow chart of an exemplary computer-implemented method for automatically determining whether a user response satisfies a standing order in accordance with the methods discussed in the context of FIG. 4. The method 430 disclosed in FIG. 5 can be practiced in Networking Environment 100 via elements discussed in the context of FIGS. 1, 2, and 3 above.

In step 510, an authorized prescriber is determined from a questionnaire response. Initially, the questionnaire response is received. An identifier associated with an authorized prescriber can be provided by a patient in the questionnaire response. For instance, the patient may provide the name of the authorized prescriber, as discussed above. The identifier can be, for instance, parsed from the questionnaire response and compared with names of authorized prescribers stored in Data Store 150 and/or Kiosk Database 114. Step 510 can be conducted by Questionnaire Module 325 of Prescription Processing Engine 142, or alternatively by Questionnaire Engine 117.

In step 520, a request for prescription requirements associated with a standing order of the prescriber is transmitted. If the authorized prescriber is determined, prescription requirements associated with the standing order of the prescriber are requested. Prescription requirements can be based on the authorized prescriber's preferences, in the form of questions selected for their questionnaire and their designated questionnaire responses that satisfy their standing order. Prescription requirements may also take the form of mandatory questions and questionnaire responses designated by the manufacturer of the product, as discussed above. Prescription requirements can be requested from Data Store 150 and/or Kiosk Database 114. In addition, step 520 can be conducted by, for instance, Response Validation Module 305 and/or by Processing Engine 118.

In step 530, a determination is automatically made as to whether the user response satisfies the prescription requirements. The determination is related to whether the questionnaire response provided by the patient satisfies the prescription requirements. This can be determined in several ways. For instance, if a patient does not meet prescription requirements in accordance with a mandatory question, then the patient may not satisfy the prescription requirements. In another instance, a patient may exceed threshold limits set for questions by the authorized prescriber, and therefore satisfy the prescription requirements. In some embodiments, questionnaire responses provided by the patient can be compared to the questionnaire response set by the authorized prescriber for the questionnaire, in order to determine whether the patient has satisfied the prescription requirements associated with the standing order. The questionnaire response can be validated by Processing Engine and/or Response Validation Module 305.

If the prescription requirements are met, a prescription is issued in step 540 by Prescription Module 310 or Prescription Generation Engine 119.

The above-described functions and/or methods may include instructions that are stored on storage media. The instructions can be retrieved and executed by a processor. Some examples of instructions are software, program code, and firmware. Some examples of storage media are memory devices, tape, disks, integrated circuits, and servers. The instructions are operational when executed by the processor to direct the processor to operate in accord with the invention. Those skilled in the art are familiar with instructions, processor(s), and storage media. Exemplary storage media in accordance with embodiments of the invention are illustrated in FIG. 1, which may include, but is not limited to any of components 110-160.

Upon reading this paper, it will become apparent to one skilled in the art that various modifications can be made to the systems, methods, and media disclosed herein without departing from the scope of the disclosure. As such, this disclosure is not to be interpreted in a limiting sense but as a basis for support of the appended claims.

What is claimed is:

1. A device for automatically generating a prescription for a prescription product, the device comprising:
a user interface;
a questionnaire engine configured to provide a questionnaire to a user and receive user response data through the user interface;
a processing engine configured to automatically determine whether the user response data satisfies prescription requirements; and
a prescription generation engine configured to be executed by a processor to issue the prescription for a prescription product for a satisfied standing order.

2. The device of claim 1, wherein the prescription requirements are associated with a standing order associated with an authorized prescriber.

3. The device of claim 1, wherein the device is configured to determine an authorized prescriber from the user response.

4. The device of claim 1, further comprising a dispensing device configured to dispense the prescription product.

5. The device of claim 1, further comprising a payment device.

6. The device of claim 1, further comprising a display device, the display device configured to display the questionnaire.

7. The device of claim 1, further comprising a biometrics input device configured to receive biometric data corresponding to a user of the device.

8. The device of claim 1, wherein the device is a kiosk.

9. The device of claim 1, wherein the device is a mobile device.

10. The device of claim 1, wherein the device is a set-top box.

11. A method for automatically generating a prescription for a prescription product, the method comprising:
receiving a standing order for the prescription product via a network;
receiving a user response to a questionnaire;
executing instructions stored in memory to automatically determine by a prescription processing engine whether the user response satisfies the standing order; and
executing instructions stored in memory to issue the prescription by a prescription processing engine for the prescription product for a satisfied standing order.

12. The method of claim 11, wherein the user response is received from a user through a kiosk.

13. The method of claim 11, wherein the standing order is associated with an authorized prescriber of the prescription product.

14. The method of claim 11, wherein the user response is automatically compared to one or more prescription requirements.

15. The method of claim 11, wherein automatically determining whether the user response satisfies the standing order includes accessing a database.

16. The method of claim 12, further comprising printing the prescription at a kiosk for the user.

17. The method of claim 12, further comprising providing instructions to dispense the prescription product from the kiosk.

18. The method of claim 17, further comprising updating the standing order upon generating the prescription.

19. The method of claim 12, further comprising providing the questionnaire for display on a display device associated with the kiosk.

20. The method of claim 11, further comprising storing the generated prescription in association with the standing order.

21. The method of claim 9, further comprising communicating the generated prescription to the user.

22. The method of claim 21, wherein the message is communicated to a kiosk.

23. The method of claim 21, wherein the generated prescription is communicated to the prescriber.

24. A computer readable storage medium having embodied thereon a program, the program being executable by a computer to perform a method for generating a prescription for a prescription product, the method comprising:
receiving a standing order for the prescription product via a network;
receiving a user response to a questionnaire over the network;
automatically determining whether the user response satisfies the standing order; and
issuing the prescription for the prescription product for a satisfied standing order.

25. The method of claim 24, wherein generating the prescription further comprises receiving a payment.

26. The method of claim 24, wherein generating the prescription further comprises making a payment.

27. The method of claim 24, further comprising receiving a request for a prescriber, the prescriber associated with the standing order.
